(19) United States
(12) Patent Application Publication
(10) Pub. No.: US 2026/0092945 A1
(43) Pub. Date: Apr. 2, 2026

(54) ACCELEROMETER

(71) Applicant: AAC Kaitai Technologies (Wuhan) CO., LTD., Wuhan (CN)

(72) Inventors: Yang Li, Wuhan (CN); Lingcheng Kong, Wuhan (CN); Zhan Zhan, Wuhan (CN); Shitao Yan, Wuhan (CN); Xiao Kan, Wuhan (CN); Shan Yang, Wuhan (CN); Zhao Ma, Wuhan (CN); Kahkeen Lai, Singapore (SG); Qiuyu Tan, Singapore (SG)

(21) Appl. No.: 18/979,433

(22) Filed: Dec. 12, 2024

Related U.S. Application Data
(63) Continuation of application No. PCT/CN2024/122873, filed on Sep. 30, 2024.

(51) Int. Cl. G01P 15/125; G01P 15/08

(52) U.S. Cl. CPC G01P 15/125; G01P 2015/0831; G01P 2015/0848

(57) ABSTRACT

Disclosed is an accelerometer. The accelerometer includes: an outer coupling structure, a detection structure connected to the outer coupling structure and an inner coupling structure. The detection structure includes anchors connected to the outer coupling structure, two seesaw structures elastically connected to the anchors, and a displacement detection component. The two seesaw structures are oppositely arranged, and the outer coupling structure includes an outer coupling structure inner ring that is coupled to the outer sides of the two seesaw structures and an outer coupling structure outer ring that encircles an outer circumference of the outer coupling structure inner ring. The accelerometer further includes a detection electrode plate secured to a side, close to the outer coupling structure, of the inner coupling structure. The anchors are evenly distributed at a center of the outer coupling structure, and the inner coupling structure is distributed around the anchors.

### CROSS REFERENCE TO RELATED APPLICATIONS

The present application is a continuation of PCT Patent Application No. PCT/CN2024/122873, entitled “ACCELEROMETER,” filed Sep. 30, 2024, which is incorporated herein by reference in its entirety.

### TECHNICAL FIELD

Embodiments of the present disclosure relate to the technical field of micro-mechanical structures, and in particular, to an accelerometer.

### BACKGROUND

Accelerometers are sensors for measuring an acceleration which is a fundamental physical quantity. Typically, an accelerometer includes mechanical acceleration sensitivity and displacement measurement components. In the case that an acceleration acts on the accelerometer, in a commonly used mechanical acceleration sensitivity component, a proof mass, which is asymmetrically positioned along a rotation axis, rotate around a rotation axis due to the effect of acceleration to drive a torsion spring to rotate. This causes a corresponding capacitor electrode plate of the structure to generate an out-of-plane displacement. By arranging capacitor electrode plates above or below the corresponding capacitor electrode plate regions on the structure, a differential capacitance is formed. In this way, acceleration variations may be measured by detecting capacitance variations.

In the related art, the accelerometer includes a base and a detection structure connected to the base. The detection structure includes anchors secured to the base, a seesaw structure elastically connected to the anchors, an inner coupling structure connected to an inner side of the seesaw structure, an outer coupling structure connected to an outer side of the seesaw structure, and a displacement detection component located on the outer coupling structure and inner coupling structure. The two seesaw structures are arranged opposite each other. The outer coupling structure includes an outer coupling structure inner ring coupled to outer sides of the two seesaw structures and an outer coupling structure outer ring encircling an outer side of the outer coupling structure inner ring. The anchors are distributed on the outer coupling structure inner ring.

However, the distribution of the anchors on the outer coupling structure results in the anchors being more dispersed across the structure. This causes the entire structure to be more affected by a stress during the manufacturing process, consequently making the base more prone to deformation and reducing robustness of the structure.

Therefore, it is necessary to provide a new accelerometer to address the above technical problem.

### SUMMARY

The embodiments of the present disclosure are intended to provide an accelerometer in which anchors are arranged at the center of the entire structure such that the structure is less affected by a stress during the manufacturing process, and thus process errors are reduced and higher robustness of the structure is achieved.

Accordingly, the embodiments of the present disclosure provide an accelerometer. The accelerometer includes an outer coupling structure, a detection structure connected to the outer coupling structure, and an inner coupling structure. The detection structure includes anchors connected to the outer coupling structure, two seesaw structures elastically connected to the anchors, and a displacement detection component arranged on both the outer coupling structure and the inner coupling structure. Inner sides of the two seesaw structures are coupled to the inner coupling structure, and outer sides of the two seesaw structures are coupled to the outer coupling structure. The two seesaw structures are oppositely arranged, and the outer coupling structure includes an outer coupling structure inner ring that is coupled to the outer sides of the two seesaw structures and an outer coupling structure outer ring that encircles an outer circumference of the outer coupling structure inner ring. The accelerometer further includes a detection electrode plate secured to a side, close to the outer coupling structure, of the inner coupling structure. The anchors are evenly distributed at a center of the outer coupling structure, and the inner coupling structure is distributed around the anchors. The detection structure further includes a first elastic member connecting the outer coupling structure inner ring to a seesaw structure corresponding to the outer coupling structure inner ring, a second elastic member connecting the outer coupling structure inner ring to the outer coupling structure outer ring, and a third elastic member connecting the detection electrode plate to a seesaw structure corresponding to the detection electrode plate.

In some embodiments, four anchors are provided, and are evenly distributed at a geometric center of the outer coupling structure.

In some embodiments, a plurality of positive and negative capacitor electrode plates on the outer coupling structure inner ring and the inner coupling structure are staggered.

In some embodiments, the inner coupling structure is provided with a plurality of connection beams, and the inner coupling structure is connected to the two seesaw structures via the plurality of connection beams.

In some embodiments, a length direction of the outer coupling structure is defined as a direction of an X-axis, a width direction of the outer coupling structure is defined as a direction of a Y-axis, and a thickness direction of the outer coupling structure is defined as a direction of a Z-axis. The two seesaw structures are symmetrically arranged on the outer coupling structure with respect to the Y-axis. The displacement detection component includes a plurality of X-axis acceleration detection units and a plurality of Y-axis acceleration detection units arranged on the outer coupling structure, and a plurality of Z-axis acceleration detection units arranged on the outer coupling structure inner ring and the inner coupling structure. The plurality of Y-axis acceleration detection units are arranged adjacent to the plurality of X-axis acceleration detection units. The plurality of X-axis acceleration detection units are symmetrically distributed with respect to the Y-axis, and the plurality of X-axis acceleration detection units are symmetrically distributed with respect to the X-axis. The plurality of Y-axis acceleration detection units are symmetrically distributed with respect to the X-axis, and the plurality of Y-axis acceleration detection units are symmetrically distributed with respect to the Y-axis. The plurality of Z-axis acceleration detection units are centrally symmetrically distributed with respect to a coordinate origin.

In some embodiments, the detection electrode plate includes a first detection plate, a second detection plate, a third detection plate, a fourth detection plate, a fifth detection plate, a sixth detection plate, a seventh detection plate, an eighth detection plate, a ninth detection plate, and a tenth detection plate that are arranged at intervals in a ring-shaped pattern on the outer coupling structure inner ring and the inner coupling structure. The first detection plate, the second detection plate, the third detection plate, the fourth detection plate, and the fifth detection plate are arranged symmetrically to the sixth detection plate, the seventh detection plate, the eighth detection plate, the ninth detection plate, and the tenth detection plate respectively with respect to the X-axis.

Capacitor electrode plates on the first detection plate, the second detection plate, the third detection plate, the fourth detection plate, and the fifth detection plate are arranged in a configuration of staggered positive and negative electrodes.

Capacitor electrode plates on the sixth detection plate, the seventh detection plate, the eighth detection plate, the ninth detection plate, and the tenth detection plate have polarity opposite to the capacitor electrode plates on the first detection plate, the second detection plate, the third detection plate, the fourth detection plate, and the fifth detection plate respectively.

In some embodiments, the detection electrode plate includes a first detection plate, a second detection plate, a third detection plate, a fourth detection plate, a fifth detection plate, a sixth detection plate, a seventh detection plate, an eighth detection plate, a ninth detection plate, a tenth detection plate, an eleventh detection plate, a twelfth detection plate, a thirteenth detection plate, a fourteenth detection plate, a fifteenth detection plate, and a sixteenth detection plate that are arranged at intervals in a ring-shaped pattern on the outer coupling structure inner ring and the inner coupling structure. The first detection plate, the second detection plate, the third detection plate, the fourth detection plate, the fifth detection plate, the sixth detection plate, the seventh detection plate, and the eighth detection plate are arranged symmetrically to the ninth detection plate, the tenth detection plate, the eleventh detection plate, the twelfth detection plate, the thirteenth detection plate, the fourteenth detection plate, the fifteenth detection plate, and the sixteenth detection plate respectively with respect to the X-axis.

Capacitor electrode plates on the first detection plate, the second detection plate, the third detection plate, the fourth detection plate, the fifth detection plate, the sixth detection plate, the seventh detection plate, and the eighth detection plate are arranged in a configuration of staggered positive and negative electrodes.

Capacitor electrode plates on the ninth detection plate, the tenth detection plate, the eleventh detection plate, the twelfth detection plate, the thirteenth detection plate, the fourteenth detection plate, the fifteenth detection plate, and the sixteenth detection plate have polarity opposite to the capacitor electrode plates on the first detection plate, the second detection plate, the third detection plate, the fourth detection plate, the fifth detection plate, the sixth detection plate, the seventh detection plate, and the eighth detection plate respectively.

In some embodiments, the detection electrode plate includes a first detection plate, a second detection plate, a third detection plate, a fourth detection plate, a fifth detection plate, a sixth detection plate, a seventh detection plate, and an eighth detection plate that are arranged at intervals in a ring-shaped pattern on the outer coupling structure inner ring and the inner coupling structure. The first detection plate, the second detection plate, the third detection plate, and the fourth detection plate are arranged symmetrically to the fifth detection plate, the sixth detection plate, the seventh detection plate, and the eighth detection plate respectively with respect to the X-axis.

Capacitor electrode plates on the first detection plate, the second detection plate, the third detection plate, and the fourth detection plate are arranged in a configuration of stagged positive and negative electrodes.

Capacitor electrode plates on the fifth detection plate, the sixth detection plate, the seventh detection plate, and the eighth detection plate have polarity opposite to the capacitor electrode plates on the first detection plate, the second detection plate, the third detection plate, and the fourth detection plate respectively.

In some embodiments, the detection electrode plate includes a first detection plate, a second detection plate, a third detection plate, a fourth detection plate, a fifth detection plate, and a sixth detection plate that are arranged at intervals in a ring-shaped pattern on the outer coupling structure inner ring and the inner coupling structure. The first detection plate, the second detection plate, and the third detection plate are arranged symmetrically to the fourth detection plate, the fifth detection plate, and the sixth detection plate respectively with respect to the X-axis.

Capacitor electrode plates on the first detection plate, the second detection plate, and the third detection plate are arranged in a configuration of stagged positive and negative electrodes.

Capacitor electrode plates on the fourth detection plate, the fifth detection plate, and the sixth detection plate have polarity opposite to the capacitor electrode plates on the first detection plate, the second detection plate, and the third detection plate respectively.

In some embodiments, the detection electrode plate includes a first detection plate, a second detection plate, a third detection plate, a fourth detection plate, a fifth detection plate, a sixth detection plate, a seventh detection plate, an eighth detection plate, a ninth detection plate, a tenth detection plate, an eleventh detection plate, a twelfth detection plate, a thirteenth detection plate, a fourteenth detection plate, a fifteenth detection plate, and a sixteenth detection plate that are juxtaposed along the direction of the X-axis on the outer coupling structure inner ring and the inner coupling structure. The first detection plate, the second detection plate, the third detection plate, the fourth detection plate, the fifth detection plate, the sixth detection plate, the seventh detection plate, and the eighth detection plate are arranged symmetrically to the ninth detection plate, the tenth detection plate, the eleventh detection plate, the twelfth detection plate, the thirteenth detection plate, the fourteenth detection plate, the fifteenth detection plate, and the sixteenth detection plate respectively with respect to the X-axis.

A capacitor electrode plate on the first detection plate and the eighth detection plate have the same polarity, and capacitor electrode plates on any adjacent two of the second detection plate to the seventh detection plate have the same polarity and are arranged in a configuration of staggered positive and negative electrodes relative to the capacitor electrode plates on the first detection plate and the eighth detection plate respectively.

Capacitor electrode plates on the ninth detection plate, the tenth detection plate, the eleventh detection plate, the twelfth detection plate, the thirteenth detection plate, the fourteenth detection plate, the fifteenth detection plate, and the sixteenth detection plate have polarity opposite to the capacitor electrode plates on the first detection plate, the second detection plate, the third detection plate, the fourth detection plate, the fifth detection plate, the sixth detection plate, the seventh detection plate, and the eighth detection plate respectively.

Compared to the related art, in the accelerometer according to the embodiments of the present disclosure, the two seesaw structures are oppositely arranged, and the outer coupling structure includes the outer coupling structure inner ring that is coupled to the outer sides of the two seesaw structures and the outer coupling structure outer ring that encircles the outer circumference of the outer coupling structure inner ring. The accelerometer further includes the detection electrode plate secured to the side, close to the outer coupling structure, of the inner coupling structure. The anchors are evenly distributed at the center of the outer coupling structure, and the inner coupling structure is distributed in a ring-shaped pattern around the anchors. This minimizes the impact of a stress on the structure during the manufacturing process, thereby reducing process errors. Moreover, in the case that the outer coupling structure is deformed under a stress, the positive and negative capacitor electrode plates, in their initial state (without acceleration), undergo similar deformations, thereby reducing the capacitance offset and enhancing the overall robustness of the structure. The detection structure further includes the first elastic member connecting the outer coupling structure inner ring to the corresponding seesaw structure, the second elastic member connecting the outer coupling structure inner ring to the outer coupling structure outer ring, and a third elastic member connecting the detection plate to the corresponding seesaw structure. With the configuration of multiple elastic members, the detection effect is enhanced.

### BRIEF DESCRIPTION OF THE DRAWINGS

For clearer descriptions of the technical solutions according to the embodiments of the present disclosure, drawings that are to be referred for description of the embodiments are briefly described hereinafter. Apparently, the drawings described hereinafter merely illustrate some embodiments of the present disclosure. Persons of ordinary skill in the art may also derive other drawings based on the drawings described herein without any creative effort.

FIG. 1 is a schematic structural diagram of an electronic device according to a first embodiment of the present disclosure.

FIG. 2 is a schematic structural diagram of a Z-axis detection electrode plate according to the first embodiment of the present disclosure.

FIG. 3 is a schematic diagram of an X-axis detection modality according to the first embodiment of the present disclosure.

FIG. 4 is a schematic diagram of a Y-axis detection modality according to the first embodiment of the present disclosure.

FIG. 5 is a schematic diagram of a Z-axis detection modality according to the first embodiment of the present disclosure.

FIG. 6 is a schematic structural diagram of an electronic device according to a second embodiment of the present disclosure.

FIG. 7 is a schematic structural diagram of a Z-axis detection electrode plate according to the second embodiment of the present disclosure.

FIG. 8 is a schematic diagram of an X-axis detection modality according to the second embodiment of the present disclosure.

FIG. 9 is a schematic diagram of a Y-axis detection modality according to the second embodiment of the present disclosure.

FIG. 10 is a schematic diagram of a Z-axis detection modality according to the second embodiment of the present disclosure.

FIG. 11 is a schematic structural diagram of an electronic device according to a third embodiment of the present disclosure.

FIG. 12 is a schematic structural diagram of a Z-axis detection electrode plate according to the third embodiment of the present disclosure.

FIG. 13 is a schematic diagram of an X-axis detection modality according to the third embodiment of the present disclosure.

FIG. 14 is a schematic diagram of a Y-axis detection modality according to the third embodiment of the present disclosure.

FIG. 15 is a schematic diagram of a Z-axis detection modality according to the third embodiment of the present disclosure.

FIG. 16 is a schematic structural diagram of an electronic device according to a fourth embodiment of the present disclosure.

FIG. 17 is a schematic structural diagram of a Z-axis detection electrode plate according to the fourth embodiment of the present disclosure.

FIG. 18 is a schematic diagram of an X-axis detection modality according to the fourth embodiment of the present disclosure.

FIG. 19 is a schematic diagram of a Y-axis detection modality according to the fourth embodiment of the present disclosure.

FIG. 20 is a schematic diagram of a Z-axis detection modality according to the fourth embodiment of the present disclosure.

FIG. 21 is a schematic structural diagram of an electronic device according to a fifth embodiment of the present disclosure.

FIG. 22 is a schematic structural diagram of a Z-axis detection electrode plate according to the fifth embodiment of the present disclosure.

FIG. 23 is a schematic diagram of an X-axis detection modality according to the fifth embodiment of the present disclosure.

FIG. 24 is a schematic diagram of a Y-axis detection modality according to the fifth embodiment of the present disclosure.

FIG. 25 is a schematic diagram of a Z-axis detection modality according to the fifth embodiment of the present disclosure.

FIG. 26 is a schematic structural diagram of an XZ dual-axis acceleration detection unit according to the second embodiment of the present disclosure.

FIG. 27 is a schematic diagram of an X-axis detection modality in FIG. 26.

FIG. 28 is a schematic diagram of a Z-axis detection modality in FIG. 26.

FIG. 29 is a schematic structural diagram of a YZ dual-axis acceleration detection unit according to the second embodiment of the present disclosure.

FIG. 30 is a schematic diagram of a Y-axis detection modality in FIG. 29.

FIG. 31 is a schematic diagram of a Z-axis detection modality in FIG. 29.

Reference numerals and denotations thereof: 100—accelerometer; 1—centerline; 2—detection structure; 21—anchor; 22—seesaw structure; 23—inner coupling structure; 24—outer coupling structure; 241—outer coupling structure inner ring; 242—outer coupling structure outer ring; 25—displacement detection component; 251—X-axis acceleration detection unit; 252—Y-axis acceleration detection unit; 253—Z-axis acceleration detection unit; 26—detection electrode plate; 261′—first detection plate; 262′—second detection plate; 263′—third detection plate; 264′—fourth detection plate; 265′—fifth detection plate; 266′—sixth detection plate; 267′—seventh detection plate; 268′—eighth detection plate; 269′—ninth detection plate; 2610′—tenth detection plate; 261″—first detection plate; 262″—second detection plate; 263″—third detection plate; 264″—fourth detection plate; 265″—fifth detection plate; 266″—sixth detection plate; 267″—seventh detection plate; 268″—eighth detection plate; 269″—ninth detection plate; 2610″—tenth detection plate; 2611″—eleventh detection plate; 2612″—twelfth detection plate; 2613″—thirteenth detection plate; 2614″—fourteenth detection plate; 2615″—fifteenth detection plate; 2616″—sixteenth detection plate; 261″′—first detection plate; 262″′—second detection plate; 263″′—third detection plate; 264″′—fourth detection plate; 265″′—fifth detection plate; 266″′—sixth detection plate; 2615—first detection plate; 2625—second detection plate; 2635—third detection plate; 2645—fourth detection plate; 2655—fifth detection plate; 2665—sixth detection plate; 2675—seventh detection plate; 2685—eighth detection plate; 2695—ninth detection plate; 26105—tenth detection plate; 26115—eleventh detection plate; 26125—twelfth detection plate; 26135—thirteenth detection plate; 26145—fourteenth detection plate; 3—first elastic member; 4—second elastic member; 5—third elastic member; 6—connection beam.

### DETAILED DESCRIPTION

The technical solutions in the embodiments of the present disclosure are described in detail clearly and completely hereinafter with reference to the accompanying drawings for the embodiments of the present disclosure. Apparently, the described embodiments are only a portion of embodiments of the present disclosure, but not all the embodiments of the present disclosure. Based on the embodiments of the present disclosure, all other embodiments derived by persons of ordinary skill in the art without any creative efforts shall fall within the protection scope of the present disclosure.

### First Embodiment

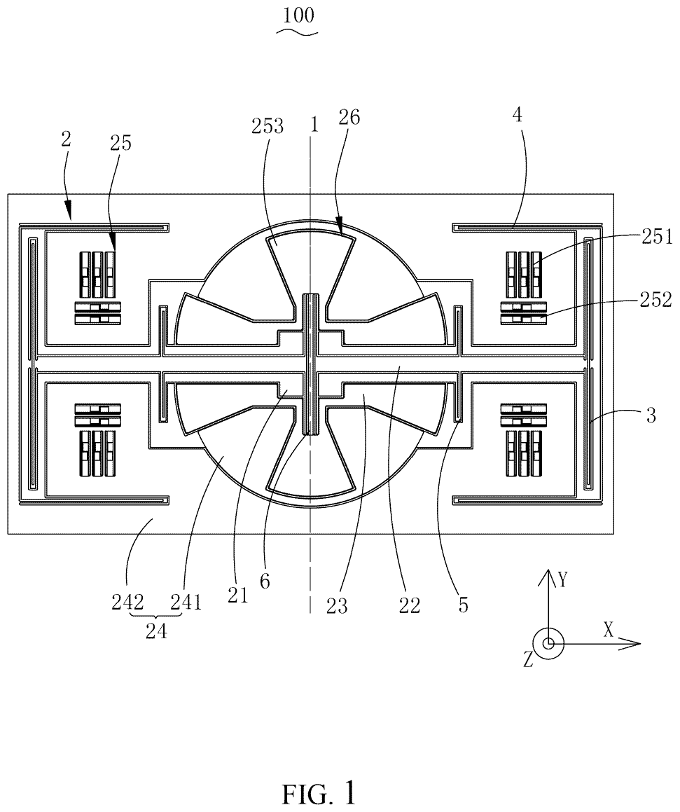

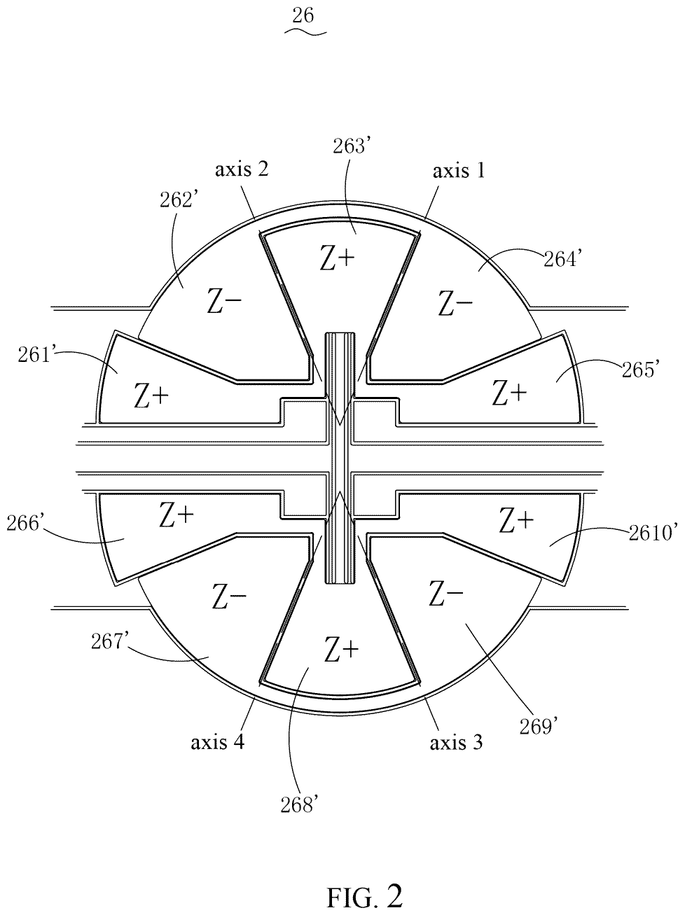

Referring to FIG. 1 and FIG. 2, an embodiment of the present disclosure provides an accelerometer 100. The accelerometer 100 includes: an outer coupling structure 24, a detection structure 2 connected to the outer coupling structure 24, and an inner coupling structure 23. The detection structure 2 includes anchors 21 connected to the outer coupling structure 24, two seesaw structures 22 elastically connected to the anchors 21, and a displacement detection component 25 arranged on both the outer coupling structure 24 and the inner coupling structure 23. Inner sides of the two seesaw structures 22 are coupled to the inner coupling structure 23, and outer sides of the two seesaw structures 22 are coupled to the outer coupling structure 24. The two seesaw structures 22 are oppositely arranged. The outer coupling structure 24 includes an outer coupling structure inner ring 241 that is coupled to the outer sides of the two seesaw structures 22 and an outer coupling structure outer ring 242 that encircles an outer circumference of the outer coupling structure inner ring 241. The accelerometer 100 further includes a detection electrode plate 26. The detection electrode plate 26 is secured to a side, close to the outer coupling structure 24, of the inner coupling structure 23. The anchors 21 are evenly distributed at a center of the outer coupling structure 24. The inner coupling structure 23 is distributed around the anchors 21 in an annular pattern. This minimizes the impact of a stress on the structure during the manufacturing process, thereby reducing process errors. In the meantime, the outer coupling structure 24 and the inner coupling structure 23 are arranged around the anchors 21 in a 0-360 degree annular pattern. In this way, in the case that the outer coupling structure 24 is deformed under a stress, positive and negative capacitor electrode plates have approximate deformations under an initial state (without acceleration), such that capacitance offsets are smaller, and thus the structure achieves a higher robustness.

In this embodiment, the outer coupling structure 24 is configured as an overall rectangular structure, and the anchors 21 are evenly distributed at a geometric center of the outer coupling structure 24.

The detection structure 2 further includes a first elastic member 3 connecting the outer coupling structure inner ring 241 to a corresponding seesaw structure 22 thereof, a second elastic member 4 connecting the outer coupling structure inner ring 241 to the outer coupling structure outer ring 242, and a third elastic member 5 connecting the detection electrode plate 26 to a corresponding seesaw structure 22 thereof. The outer coupling structure inner ring 241 is connected to the corresponding seesaw structure 22 thereof via the first elastic member 3, such that a proof mass block of the outer coupling structure 24 is capable of moving under the effect of an X-axis acceleration. The outer coupling structure outer ring 242 is connected to the outer coupling structure inner ring 241 via the second elastic member 4, such that a proof mass block of the outer coupling structure outer ring 242 is capable of moving under the effect of a Y-axis acceleration. This XY-axis elastic connection design on the inner and outer ring interface enhances a rotational modal stiffness of a proof mass of the outer coupling structure 24, improves the cross suppression ratio, and reduces cross-coupling. The detection electrode plate 26 is connected to the corresponding seesaw structure 22 thereof via the third elastic member 5, such that capacitance offsets of the detection electrode plate 26 are smaller, and thus the structure achieves a higher robustness.

In this embodiment, the first elastic member 3 is an X-axis single degree-of-freedom spring, the second elastic member 4 is a Y-axis single degree-of-freedom spring, and the third elastic member 5 is a Z-axis single degree-of-freedom spring. The first elastic member 3, the second elastic member 4, and the third elastic member 5 are exemplarily torsion springs, the accelerometer 100 is of a symmetric structure, that is, the accelerometer 100 is symmetrical with respect to a centerline 1, and the two seesaw structures 22 are respectively arranged on two sides of the centerline 1. An end, close to the centerline 1, of the seesaw structure 22 is connected to the inner coupling structure 23, and an end, away from the centerline 1, of the seesaw structure 22 is connected to the X-axis free-of-freedom spring. By sharing the same sensitive mass across three detection directions of the X-axis, Y-axis, and Z-axis, the mass of a sensitive structure is increased within a limited space, thereby improving sensitivity of the structure.

In some embodiments, four anchors 21 are provided, and are evenly distributed at a geometric center of the outer coupling structure 24. In this configuration, the Z-axis single degree-of-freedom springs are connected to the seesaw structures 22 via the anchors 21. Four Z-axis single-degree-of-freedom springs are provided, with one end of each spring close to the center connected to an anchor 21 thereof, and the other end connected to a corresponding seesaw structure 22 thereof. Each of the anchors 21 is arranged between opposing ends of the corresponding seesaw structure 22, such that the two seesaw structures 22 rotate around their respective axes (composed of the third elastic elements 5 and the anchors 21 on two sides of the same seesaw structure 22), and are symmetrical with respect the centerline 1. In this way, in-plane rotation of the seesaw structures 22 around the Z-axis is suppressed to some extent, and cross-coupling of the structure is reduced. It should be noted that, in other embodiments, the third elastic element 5 may also be a tension spring or any other type of elastic structure, which is not particularly limited herein, as long as elastic connections between the seesaw structures 22 and the anchors 21 are ensured.

In this embodiment, the detection electrode plate 26 and a plurality of positive and negative capacitor electrode plates on the outer coupling structure 24 are staggered. When the outer coupling structure 24 is deformed under a stress, the presence of the anchors 21 between the outer coupling structure 24 and the movable structure causes positive and negative capacitor electrode plates to undergo bowl-shaped deformation. By a staggered arrangement, the positive and negative capacitor electrode plates exhibit similar deformations in the initial state (without acceleration), thereby minimizing the capacitance offset.

In this embodiment, the inner coupling structure 23 is provided with a plurality of connection beams 6, and the inner coupling structure 23 is connected to the two seesaw structures 22 via the connection beams 6. In this way, the inner coupling structure 23 strengthens the constraint on the seesaw structure 22, such that the stiffness of parasitic modality such as the rotation of the outer coupling structure 24 is improved, the cross-axis suppression ratio of the structure is enhanced, and the cross-axis coupling of the accelerometer 100 is reduced.

In some embodiments, a length direction of the outer coupling structure 24 is defined as a direction of an X-axis, a width direction of the outer coupling structure 24 is defined as a direction of a Y-axis, and a thickness direction of the outer coupling structure 24 is defined as a direction of a Z-axis. The two seesaw structures 22 are symmetrically arranged on the outer coupling structure 24 with respect to the Y-axis. The displacement detection component 25 includes a plurality of X-axis acceleration detection units 251 and a plurality of Y-axis acceleration detection units 252 arranged on the outer coupling structure 24, and a plurality of Z-axis acceleration detection units 253 arranged on the outer coupling structure inner ring 241 and the inner coupling structure 23. The plurality of Y-axis acceleration detection unit 252 and the plurality of X-axis acceleration detection unit 251 are adjacently arranged.

The plurality of X-axis acceleration detection units 251 are symmetrically distributed with respect to the Y-axis, and the plurality of X-axis acceleration detection units 251 are symmetrically distributed with respect to the X-axis. The X-axis acceleration detection unit 251 includes a plurality of detection capacitors juxtaposed along the Y-axis.

The plurality of Y-axis acceleration detection units 252 are symmetrically distributed with respect to the X-axis, and the plurality of Y-axis acceleration detection units 252 are symmetrically distributed with respect to the Y-axis. The Y-axis acceleration detection unit 252 includes a plurality of detection capacitors juxtaposed along the X-axis.

The plurality of Z-axis acceleration detection units 253 are centrally symmetrically distributed with respect to a coordinate origin.

The X-axis acceleration detection units 251 are arranged on two sides connected to the same seesaw structure 22.

In this embodiment, the detection electrode plate 26 includes a first detection plate 261′, a second detection plate 262′, a third detection plate 263′, a fourth detection plate 264′, a fifth detection plate 265′, a sixth detection plate 266′, a seventh detection plate 267′, an eighth detection plate 268′, a ninth detection plate 269′, and a tenth detection plate 2610′that are arranged at intervals in a ring-shaped pattern on the outer coupling structure inner ring 241 and the inner coupling structure 23. The first detection plate 261′, the second detection plate 262′, the third detection plate 263′, the fourth detection plate 264′, and the fifth detection plate 265′are arranged symmetrically to the sixth detection plate 266′, the seventh detection plate 267′, the eighth detection plate 268′, the ninth detection plate 269′, and the tenth detection plate 2610′ respectively with respect to the X-axis.

Capacitor electrode plates on the first detection plate 261′, the second detection plate 262′, the third detection plate 263′, the fourth detection plate 264′, and the fifth detection plate 265′are arranged in a configuration of staggered positive and negative electrodes.

Capacitor electrode plates on the sixth detection plate 266′, the seventh detection plate 267′, the eighth detection plate 268′, the ninth detection plate 269′, and the tenth detection plate 2610′have polarity opposite to the capacitor electrode plates on the first detection plate 261′, the second detection plate 262′, the third detection plate 263′, the fourth detection plate 264′, and the fifth detection plate 265′respectively.

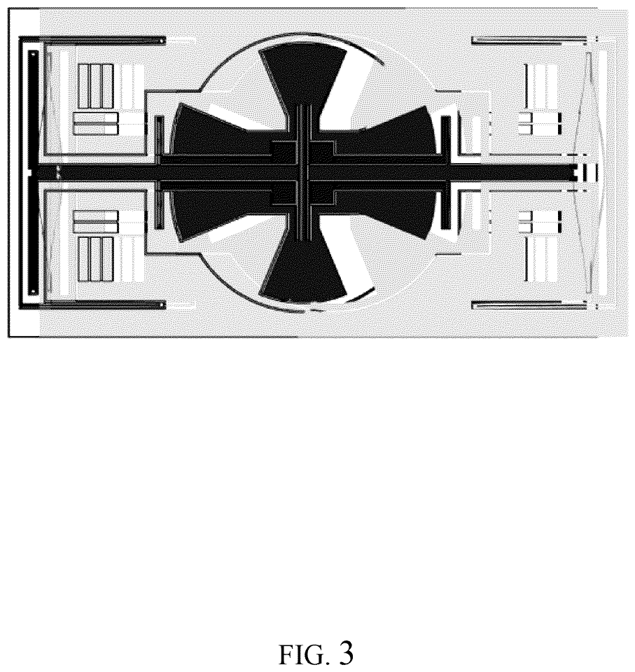

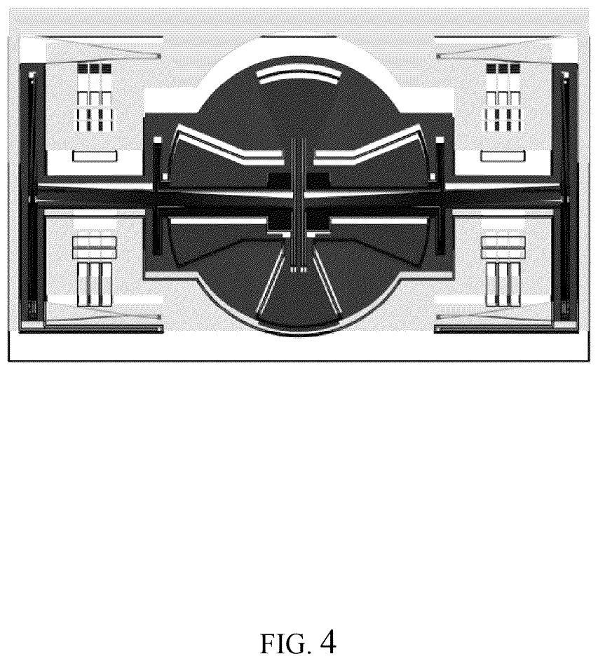

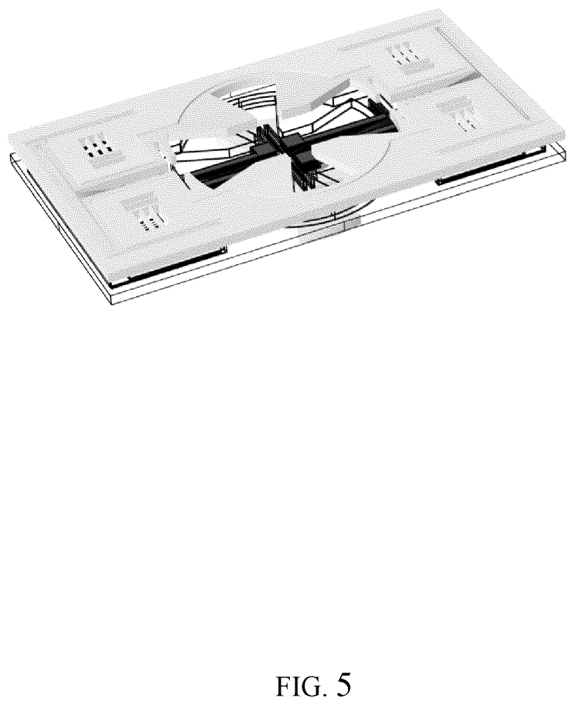

FIG. 3 to FIG. 5 illustrate X-axis, Y-axis, and Z-axis detection modalities respectively. The entire accelerometer 100 is supported by two oppositely arranged seesaw structures 22. The inner coupling structure 23 couples the inner sides of the two seesaw structures 22, while the outer coupling structure 24 couples the outer sides of the two seesaw structures 22. This arrangement ensures that the rotation of the two seesaw structures 22 around their respective axes is symmetrical relative to the centerline 1, which suppresses in-plane rotation of the seesaw structures 22 around the Z-axis to some extent and reduces cross-axis coupling of the structure. A proof mass of the accelerometer 100 is distributed on the coupling structures, with the majority concentrated on the outer coupling structure 24. In the case that an out-of-plane Z-axis acceleration occurs, the inner coupling structure and the outer coupling structure on the two sides of the seesaw structure 22 exhibit differential motion relative to the outer coupling structure 24 and a cavity cap. As illustrated in FIG. 2, all Z+ and Z− regions correspond to proof masses (alternatively, positive and negative electrodes may be interchangeable) move in opposite directions along the Z-axis. This movement causes differential changes in a Z-axis detection capacitance between the inner coupling structure 23 and the corresponding outer coupling structures 24 or the cavity cap. By detecting these changes in capacitance, the Z-axis acceleration is measured.

Specifically, the anchors 21 are arranged at a center of the entire structure, such that the impact of a stress on the structure during the manufacturing process is minimized, and thus process errors are reduced. The displacement detection component 25 within the plane measures translational motion caused by proof mass movement in the X/Y direction due to the in-plane acceleration. The detection electrode plate 26 out of the plane measures the rotation of the seesaw structure 22 caused by proof mass movement in the Z direction due to an out-of-plane acceleration.

In this embodiment, Z+ and Z− represent the capacitor electrode plates corresponding to the outer coupling structure 24 and the detection electrode plate 26. Supplementary description is made for the detection electrode plate 26 in the Z-axis and the corresponding capacitor electrode plates (as illustrated in FIG. 2) on the outer coupling structure 24 or the cavity cap. Z+ and Z− capacitor electrode plates are symmetrically distributed along axes 1, 2, 3, and 4. Axes 1, 2, 3, and 4 intersect near a center origin of the entire structure. This symmetrical arrangement effectively reduces the initial capacitance offset along the Z-axis.

### Second Embodiment

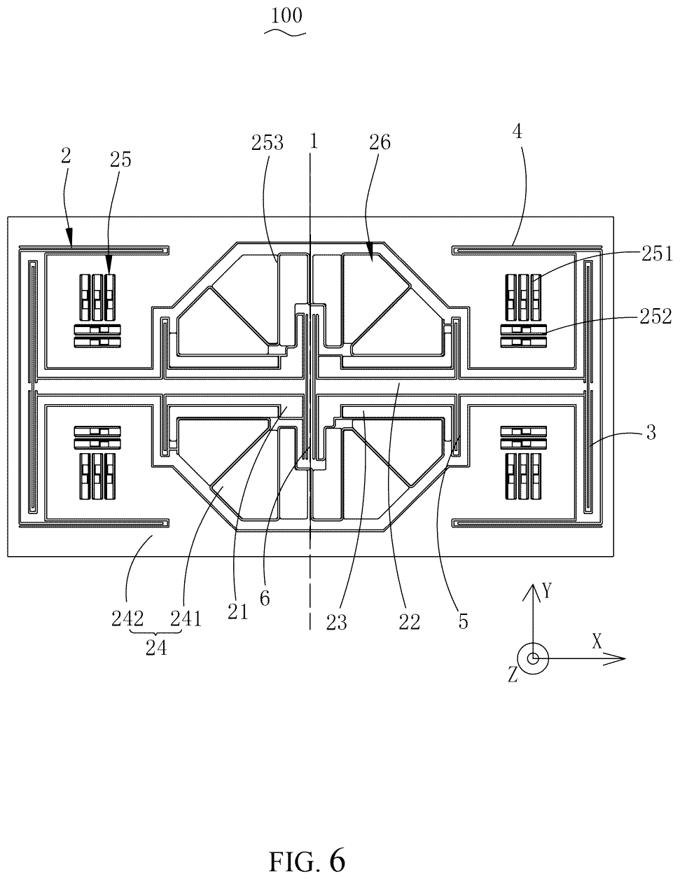

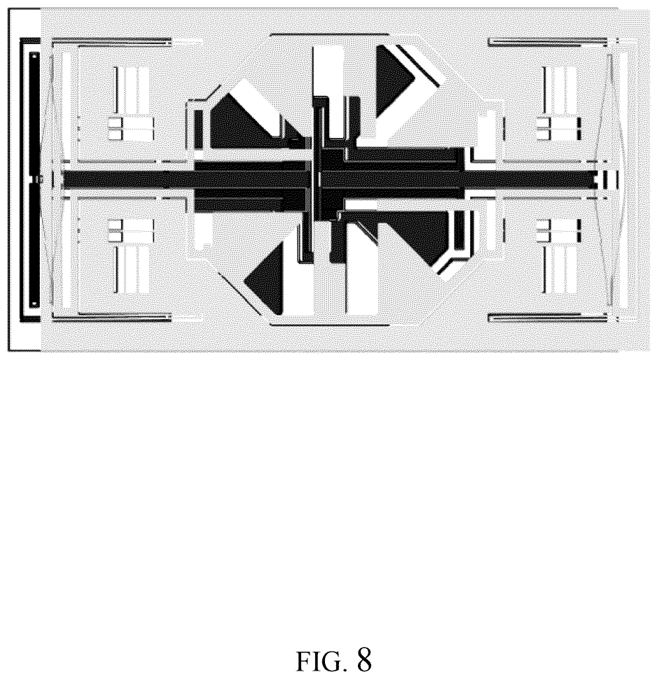

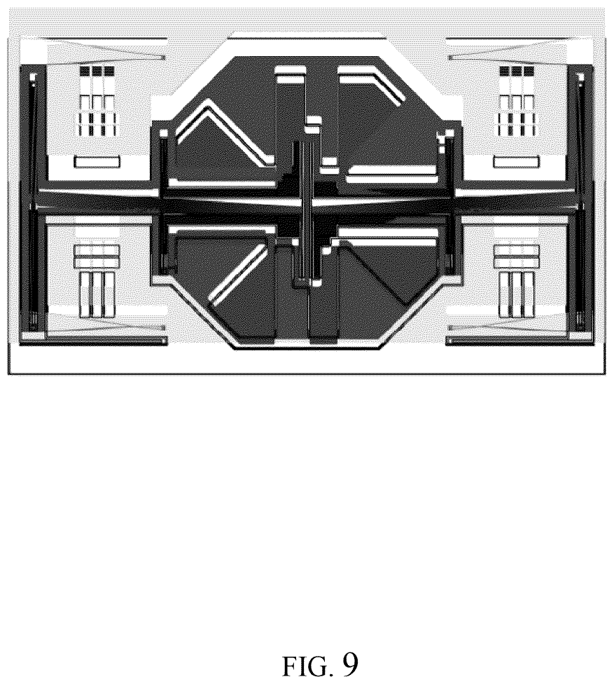

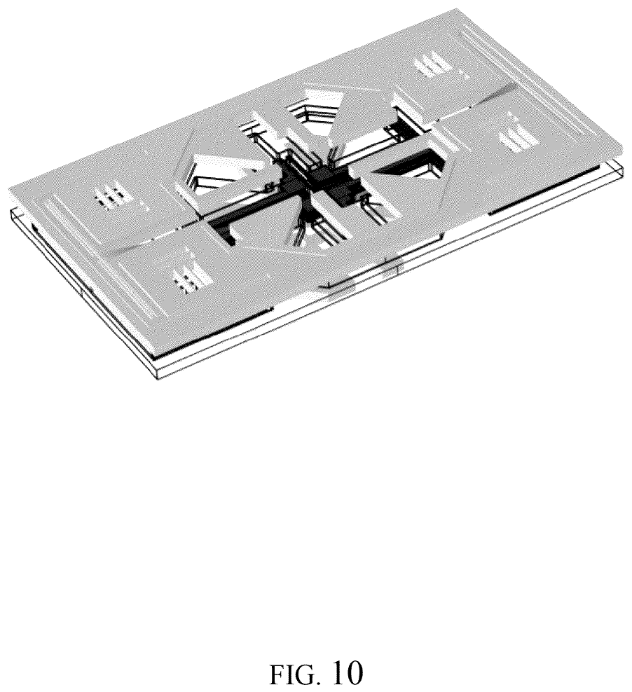

Referring to FIG. 6 to FIG. 10, based on the first embodiment, the detection electrode plate 26 includes a first detection plate 261″, a second detection plate 262″, a third detection plate 263″, a fourth detection plate 264″, a fifth detection plate 265″, a sixth detection plate 266″, a seventh detection plate 267″, an eighth detection plate 268″, a ninth detection plate 269″, a tenth detection plate 2610″, an eleventh detection plate 2611″, a twelfth detection plate 2612″, a thirteenth detection plate 2613″, a fourteenth detection plate 2614″, a fifteenth detection plate 2615″, and a sixteenth detection plate 2616″ that are arranged at intervals in a ring-shaped pattern on the outer coupling structure inner ring 241 and the inner coupling structure 23. The first detection plate 261″, the second detection plate 262″, the third detection plate 263″, the fourth detection plate 264″, the fifth detection plate 265″, the sixth detection plate 266″, the seventh detection plate 267″, the eighth detection plate 268″ are arranged symmetrically to the ninth detection plate 269″, the tenth detection plate 2610″, the eleventh detection plate 2611″, the twelfth detection plate 2612″, the thirteenth detection plate 2613″, the fourteenth detection plate 2614″, the fifteenth detection plate 2615″, and the sixteenth detection plate 2616″ respectively with respect to the X-axis.

Capacitor electrode plates on the first detection plate 261″, the second detection plate 262″, the third detection plate 263″, the fourth detection plate 264″, the fifth detection plate 265″, the sixth detection plate 266″, the seventh detection plate 267″, the eighth detection plate 268″ are arranged in a configuration of staggered positive and negative electrodes.

Capacitor electrode plates on the ninth detection plate 269″, the tenth detection plate 2610″, the eleventh detection plate 2611″, the twelfth detection plate 2612″, the thirteenth detection plate 2613″, the fourteenth detection plate 2614″, the fifteenth detection plate 2615″, and the sixteenth detection plate 2616″ have polarity opposite to the capacitor electrode plates on the first detection plate 261″, the second detection plate 262″, the third detection plate 263″, the fourth detection plate 264″, the fifth detection plate 265″, the sixth detection plate 266″, the seventh detection plate 267″, the eighth detection plate 268″ respectively.

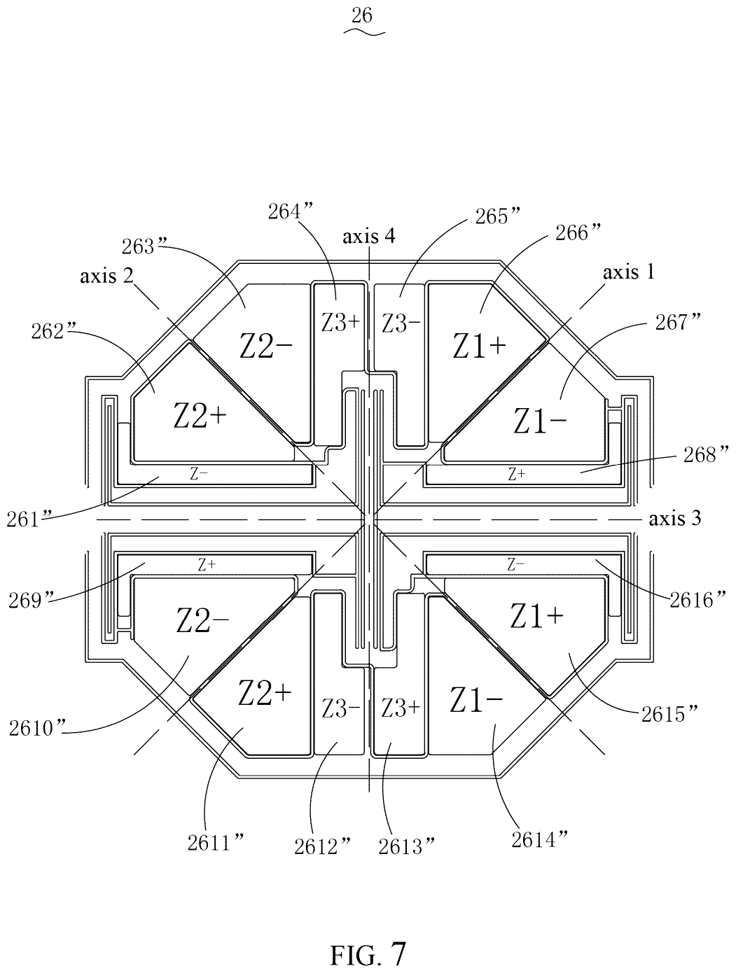

Specifically, supplementary description is made for the detection electrode plate 26 in the Z-axis and the corresponding capacitor electrode plates (as illustrated in FIG. 7) on the outer coupling structure 24 or the cavity cap. Z1+ and Z1− capacitor electrode plates are symmetrically distributed along axis 1, Z2+ and Z2− capacitor electrode plates are symmetrically distributed along axis 2, Z3+ and Z3− capacitor electrode plates are symmetrically distributed along axis 4 (Y-axis), and all positive and negative capacitor electrode plates are symmetrically distributed along axis 3 (X-axis). Axes 1, 2, 3, and 4 intersect near the center origin of the entire structure. This arrangement further reduces the initial capacitance offset along the Z-axis.

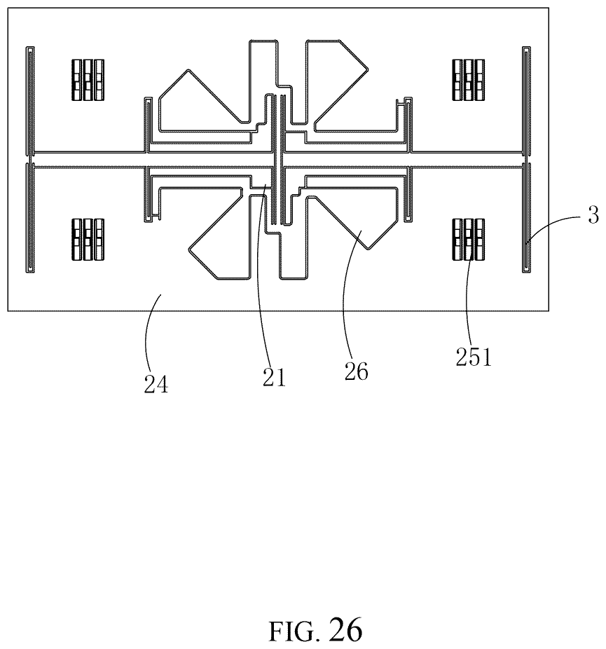

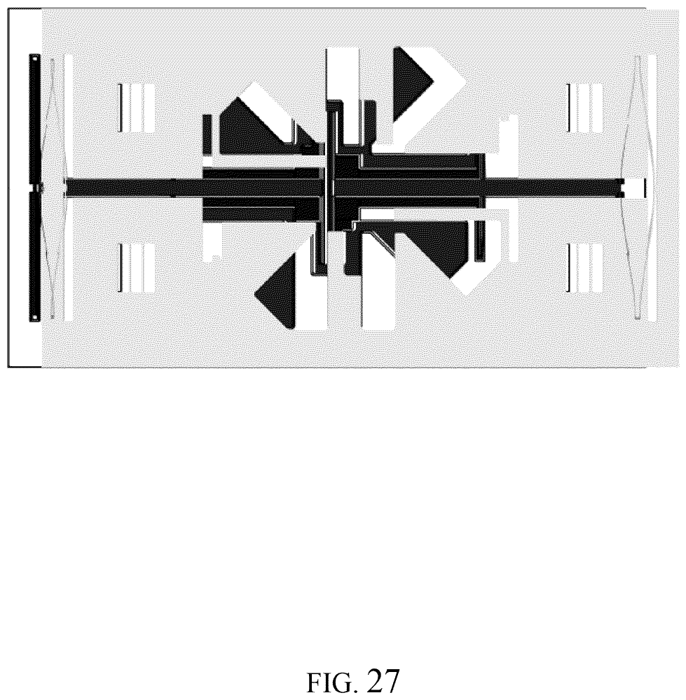

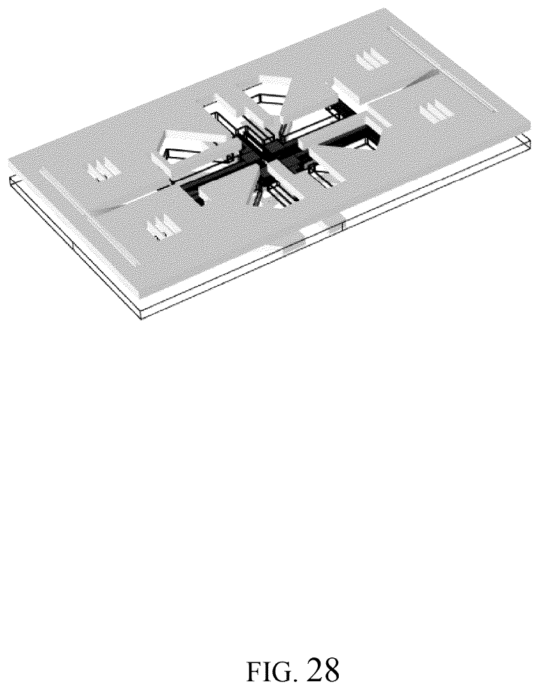

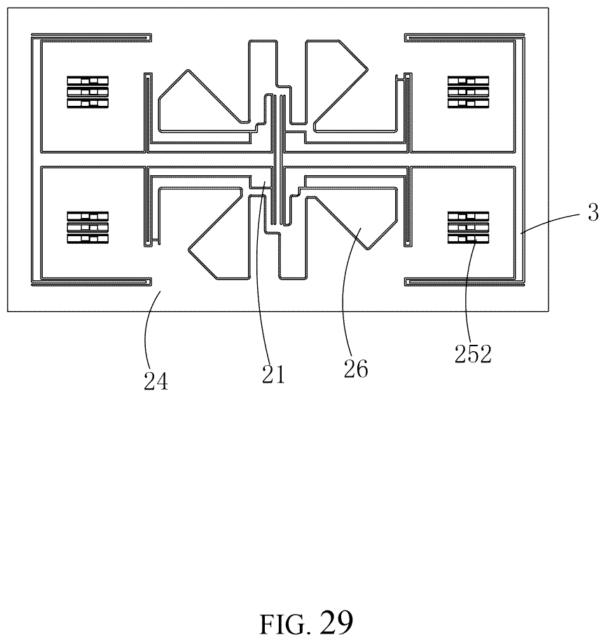

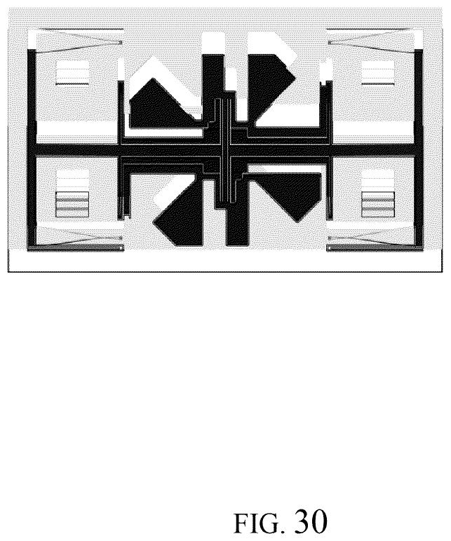

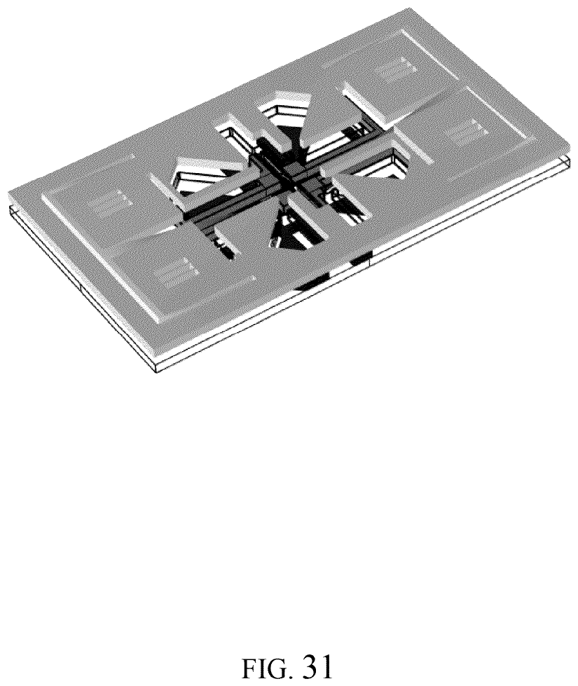

As illustrated in FIG. 26 to FIG. 28, FIG. 26 illustrates an X/Z dual-axis accelerometer derived from this embodiment, while FIG. 27 and FIG. 28 illustrate detection modalities for the X-axis and Z-axis respectively, demonstrating detection characteristics of the X-axis and Z-axis. Similarly, as illustrated in FIG. 29 to FIG. 31, FIG. 29 illustrates a Y/Z dual-axis accelerometer derived from this embodiment, while FIG. 30 and FIG. 31 illustrate detection modalities for the Y-axis and Z-axis respectively, demonstrating detection characteristics of the Y-axis and Z-axis.

### Third Embodiment

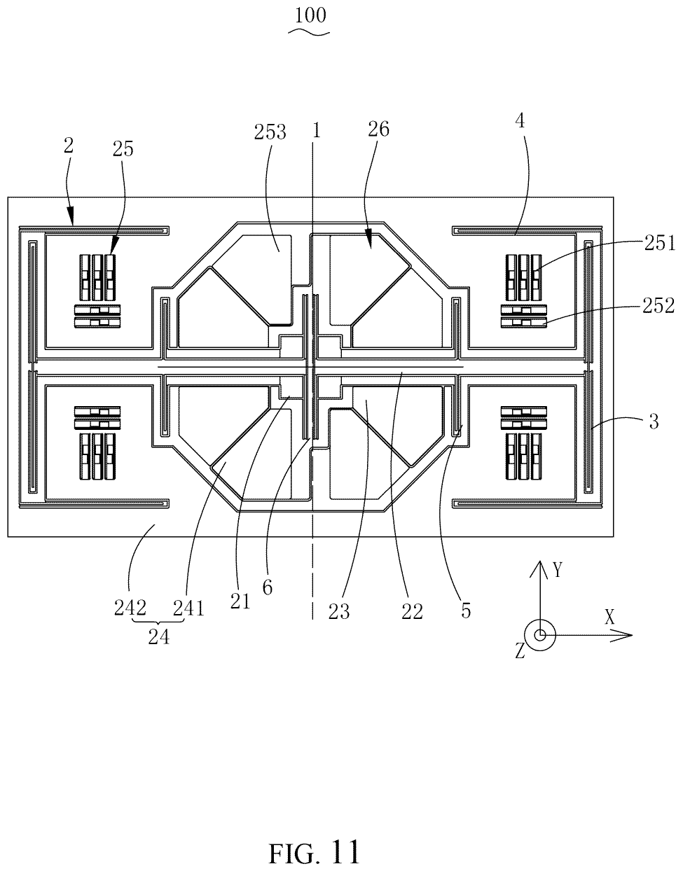

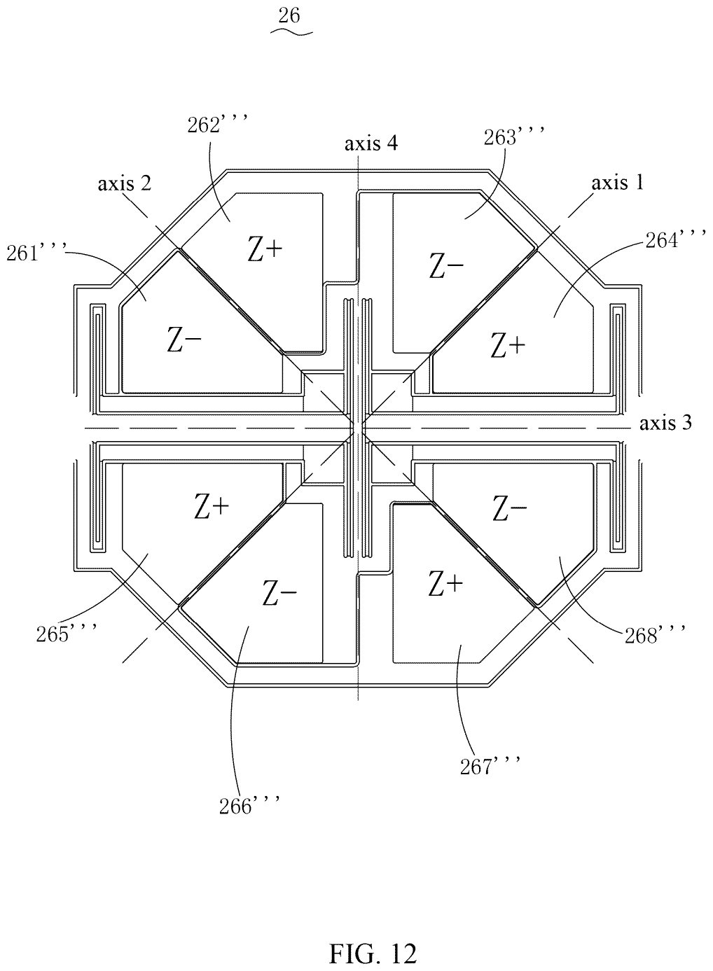

Referring to FIG. 11 and FIG. 12, in this embodiment, the detection electrode plate 26 includes a first detection plate 261″′, a second detection plate 262″′, a third detection plate 263″′, a fourth detection plate 264″′, a fifth detection plate 265″′, a sixth detection plate 266″′, a seventh detection plate 267″′, and an eighth detection plate 268″′ that are arranged at intervals in a ring-shaped pattern on the outer coupling structure inner ring 241 and the inner coupling structure 23. The first detection plate 261″′, the second detection plate 262″′, the third detection plate 263″′, the fourth detection plate 264″′ are distributed symmetrically to the fifth detection plate 265″′, the sixth detection plate 266″′, the seventh detection plate 267″′, and the eighth detection plate 268″′ respectively with respect to the X-axis.

Capacitor electrode plates on the first detection plate 261″′, the second detection plate 262″′, the third detection plate 263″′, and the fourth detection plate 264″′ are arranged in a configuration of stagged positive and negative electrodes.

Capacitor electrode plates on the fifth detection plate 265″′, the sixth detection plate 266″′, the seventh detection plate 267″′, and the eighth detection plate 268″′ have polarity opposite to the capacitor electrode plates on the first detection plate 261″′, the second detection plate 262″′, the third detection plate 263″′, the fourth detection plate 264″′ respectively.

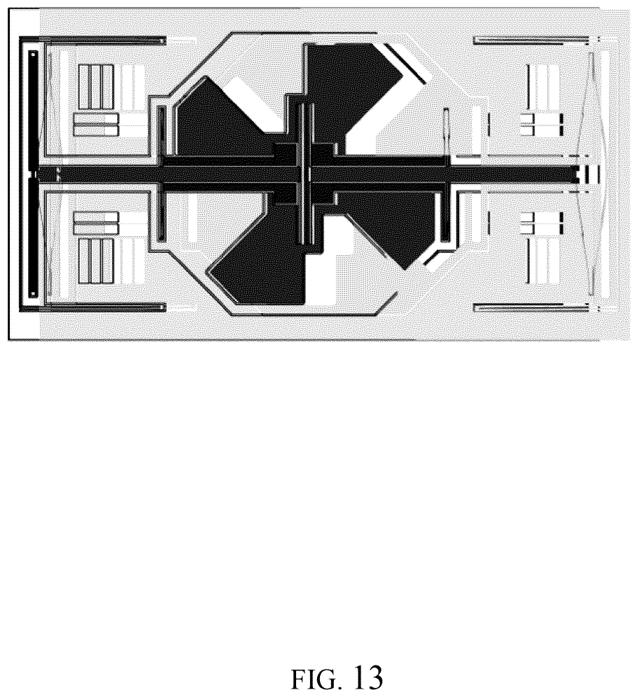

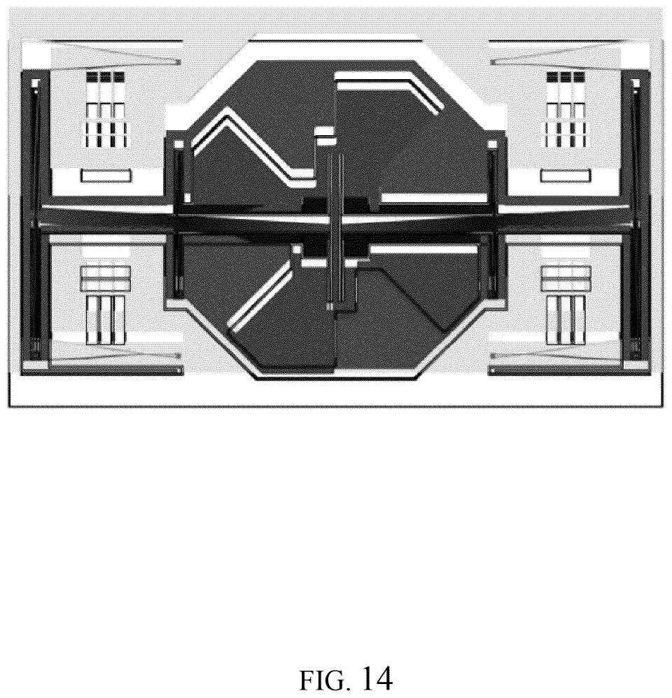

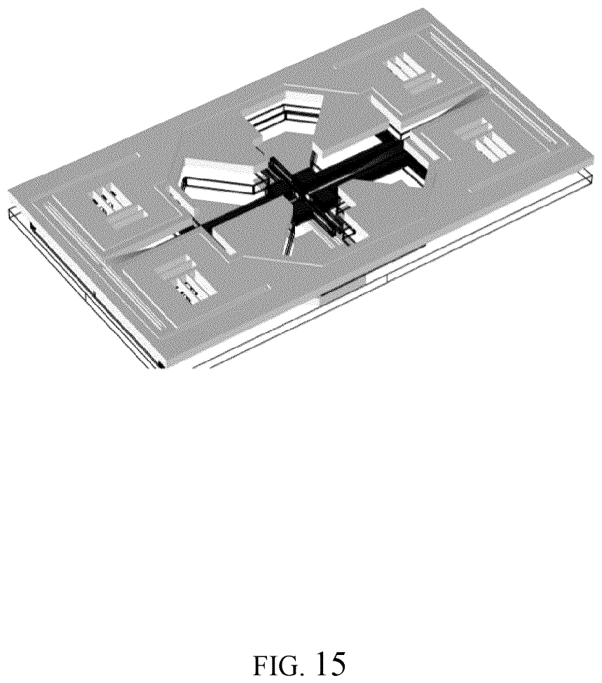

Specifically, supplementary description is made for the detection electrode plate 26 in the Z-axis and the corresponding capacitor electrode plates (as illustrated in FIG. 12) on the outer coupling structure 24 or the cavity cap. The electrode plates are all symmetrical along the X-axis (axis 3) and the Y-axis (axis 4). All the Z+ and Z− capacitor electrode plates are completely symmetrically distributed along axes 1, 2, 3, and 4. Axes 1, 2, 3, and 4 intersect near a center origin of the entire structure. Additionally, centroids of all the Z+ and Z− capacitor electrode plates are equidistant from the center origin. FIG. 13 to FIG. 15 illustrate X-axis, Y-axis, and Z-axis detection modalities respectively. This arrangement further reduces the initial capacitance offset along the Z-axis.

### Fourth Embodiment

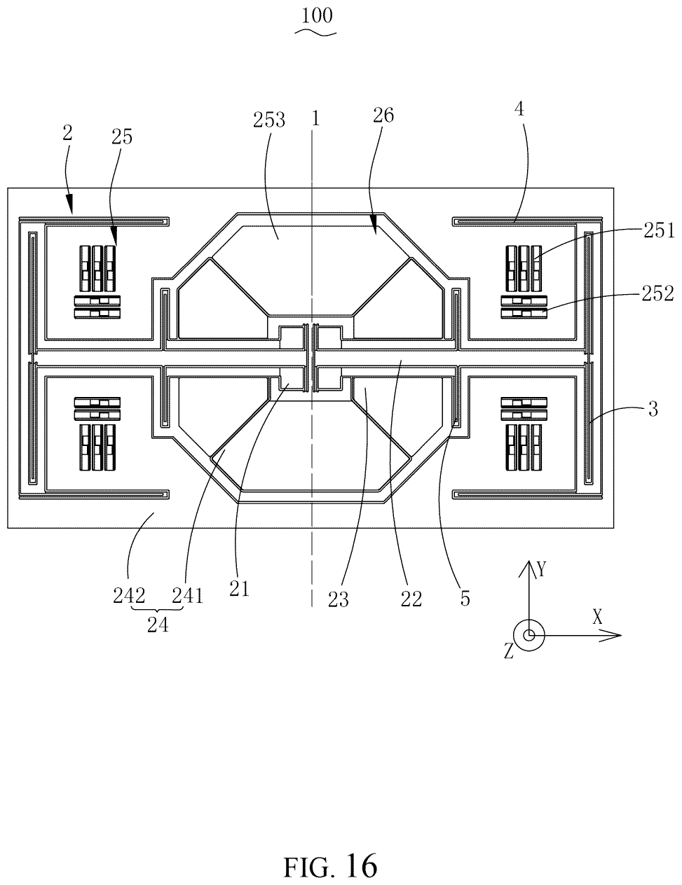

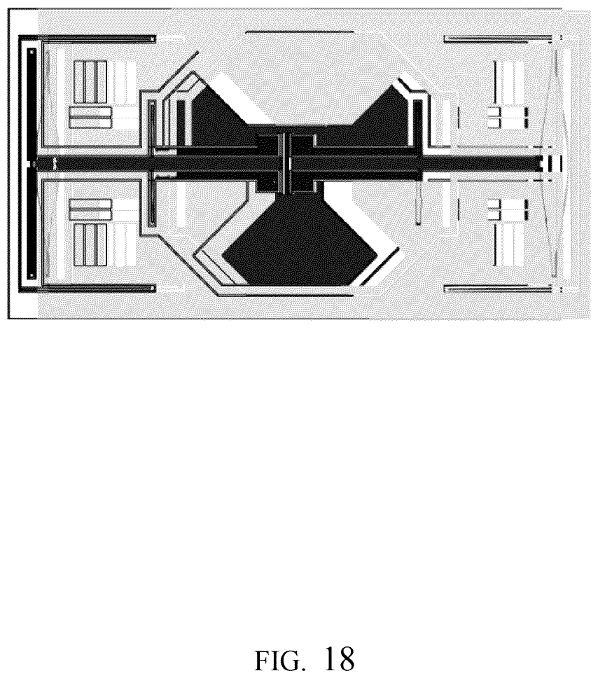

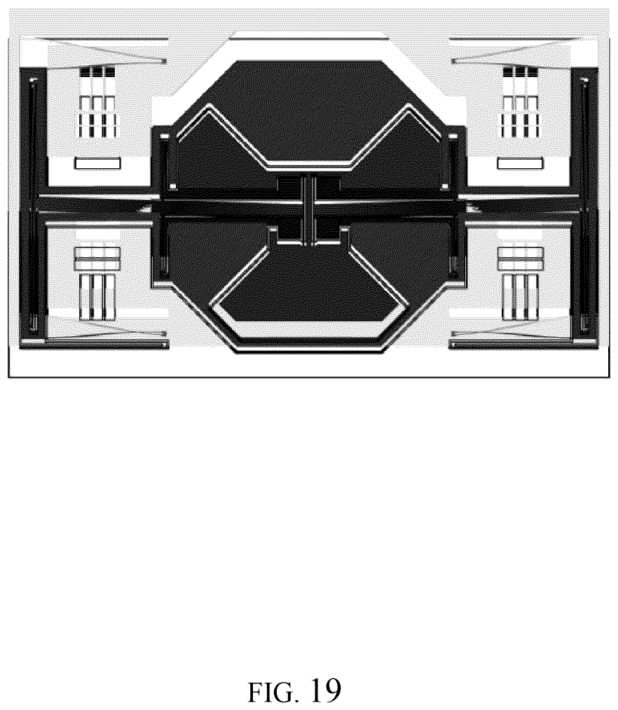

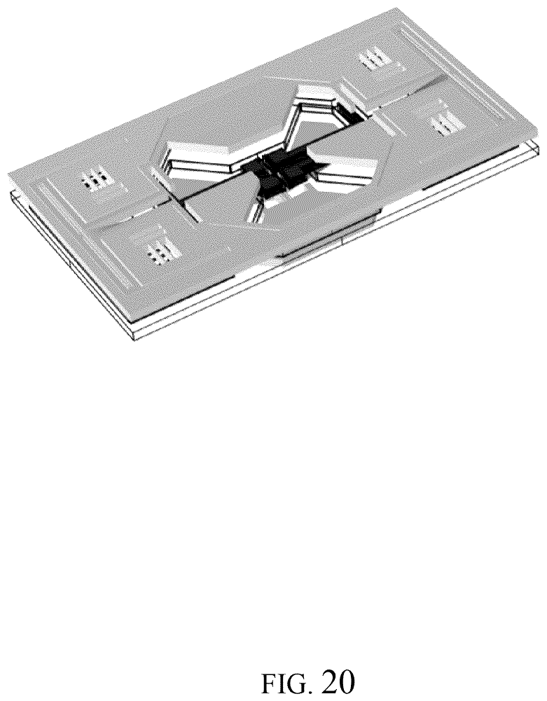

Referring to FIG. 16 to FIG. 20, in this embodiment, the detection electrode plate 26 includes a first detection plate 261″″, a second detection plate 262″″, a third detection plate 263″″, a fourth detection plate 264″″, a fifth detection plate 265″′, and a sixth detection plate 266″″ that are arranged at intervals in a ring-shaped pattern on the outer coupling structure inner ring 241 and the inner coupling structure 23. The first detection plate 261″″, the second detection plate 262″″, and the third detection plate 263″″ are distributed symmetrically to the fourth detection plate 264″″, the fifth detection plate 265″″, and the sixth detection plate 266″″ respectively with respect to the X-axis.

Capacitor electrode plates on the first detection plate 261″″, the second detection plate 262″″, and the third detection plate 263″″ are arranged in a configuration of stagged positive and negative electrodes.

Capacitor electrode plates on the fourth detection plate 264″″, the fifth detection plate 265″″, and the sixth detection plate 266″″ have polarity opposite to the capacitor electrode plates on the first detection plate 261″″, the second detection plate 262″″, and the third detection plate 263″″ respectively.

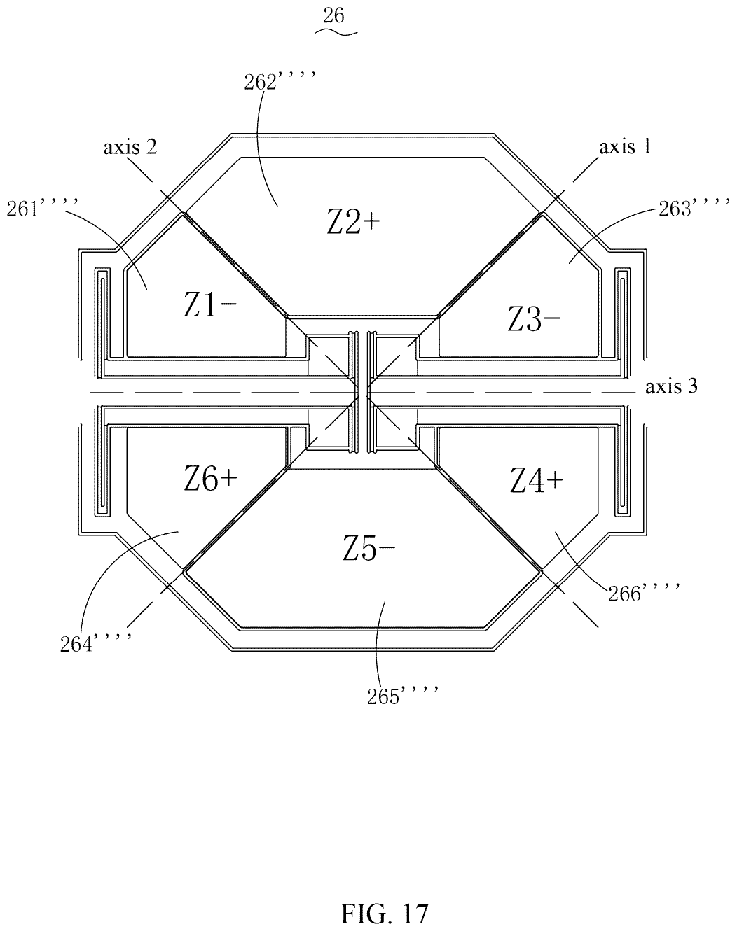

Specifically, supplementary description is made for the detection electrode plate 26 in the Z-axis and the corresponding capacitor electrode plates (as illustrated in FIG. 17) on the outer coupling structure 24 or the cavity cap. Z1−/Z6+, Z2+/Z5−, and Z3−/Z4+ capacitor electrode plates are symmetrically arranged along axis 3 (X-axis). Z1− and Z4+ capacitor electrode plates exhibit rotational symmetry around a quadrant formed by axes 2 and 3, while Z3− and Z6+ capacitor electrode plates exhibit rotational symmetry around a quadrant formed by axes 1 and 3. Axes 1, 2, and 3 intersect at a center origin of the entire structure. This arrangement further reduces the initial capacitance offset along the Z-axis.

### Fifth Embodiment

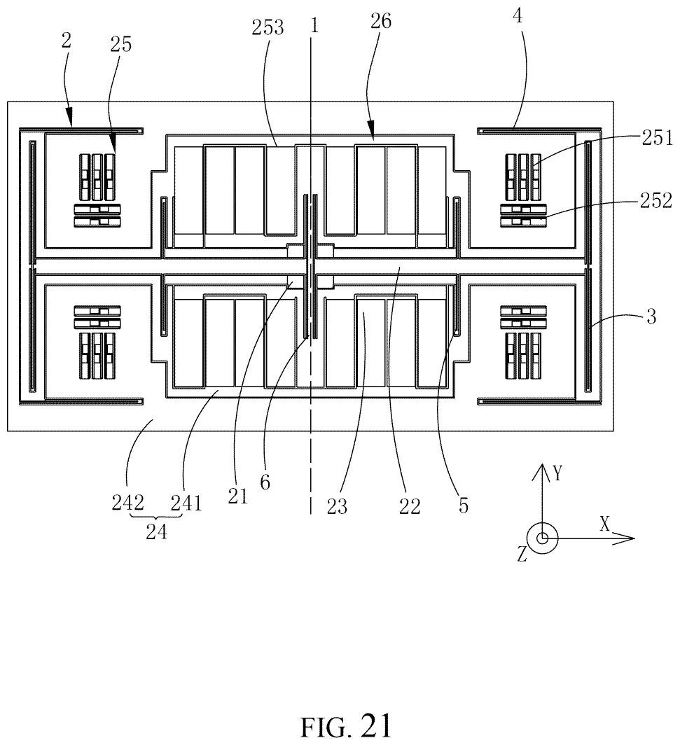

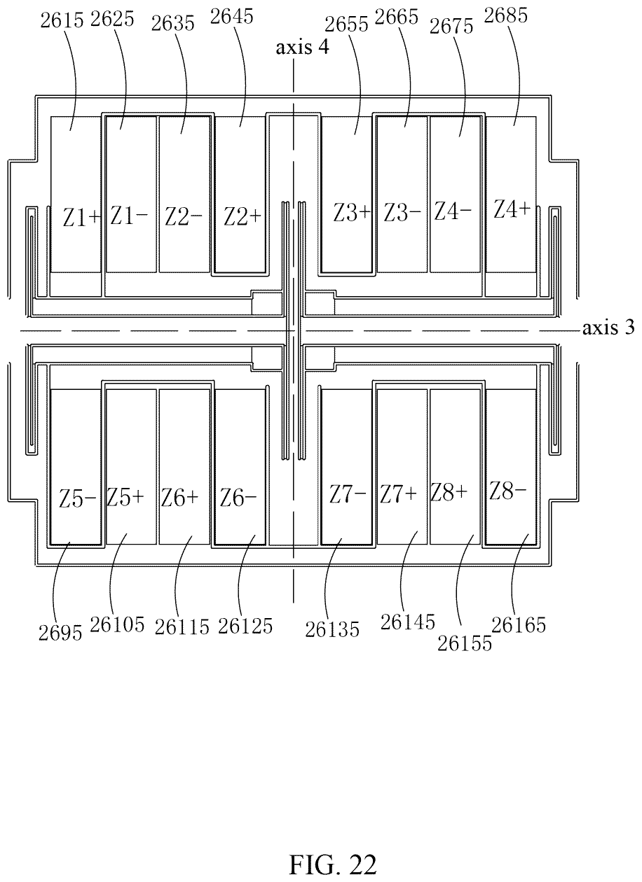

Referring to FIG. 21 and FIG. 22, in this embodiment, the detection electrode plate 26 includes a first detection plate 2615, a second detection plate 2625, a third detection plate 2635, a fourth detection plate 2645, a fifth detection plate 2655, a sixth detection plate 2665, a seventh detection plate 2675, an eighth detection plate 2685, a ninth detection plate 2695, a tenth detection plate 26105, an eleventh detection plate 26115, a twelfth detection plate 26125, a thirteenth detection plate 26135, a fourteenth detection plate 26145, a fifteenth detection plate 26155, and a sixteenth detection plate 26165 that are juxtaposed along the direction of the X-axis on the outer coupling structure inner ring 241 and the inner coupling structure 23. The first detection plate 2615, the second detection plate 2625, the third detection plate 2635, the fourth detection plate 2645, the fifth detection plate 2655, the sixth detection plate 2665, the seventh detection plate 2675, the eighth detection plate 2685 are arranged symmetrically to the ninth detection plate 2695, the tenth detection plate 26105, the eleventh detection plate 26115, the twelfth detection plate 26125, the thirteenth detection plate 26135, the fourteenth detection plate 26145, the fifteenth detection plate 26155, and the sixteenth detection plate 26165 respectively with respect to the X-axis.

A capacitor electrode plate on the first detection plate 2615 and the eighth detection plate 2685 have the same polarity, and capacitor electrode plates on any adjacent two of the second detection plate 2625 to the seventh detection plate 2675 have the same polarity and are arranged in a configuration of staggered positive and negative electrodes relative to the capacitor electrode plates on the first detection plate 2615 and the eighth detection plate 2685 respectively. Capacitor electrode plates on the fourth detection plate 2645 and the fifth detection plate 2655 have the same polarity, capacitor electrode plates on the second detection plate 2625, the third detection plate 2635, the sixth detection plate 2665 and the seventh detection plate 2675 have the same polarity; and capacitor electrode plates on the first detection plate 2615, the second detection plate 2625 the fourth detection plate 2645 and the sixth detection plate 2665 are arranged in a configuration of staggered positive and negative electrodes.

Capacitor electrode plates on the ninth detection plate 2695, the tenth detection plate 26105, the eleventh detection plate 26115, the twelfth detection plate 26125, the thirteenth detection plate 26135, the fourteenth detection plate 26145, the fifteenth detection plate 26155, and the sixteenth detection plate 26165 have polarity opposite to the capacitor electrode plates on the first detection plate 2615, the second detection plate 2625, the third detection plate 2635, the fourth detection plate 2645, the fifth detection plate 2655, the sixth detection plate 2665, the seventh detection plate 2675, the eighth detection plate 2685 respectively.

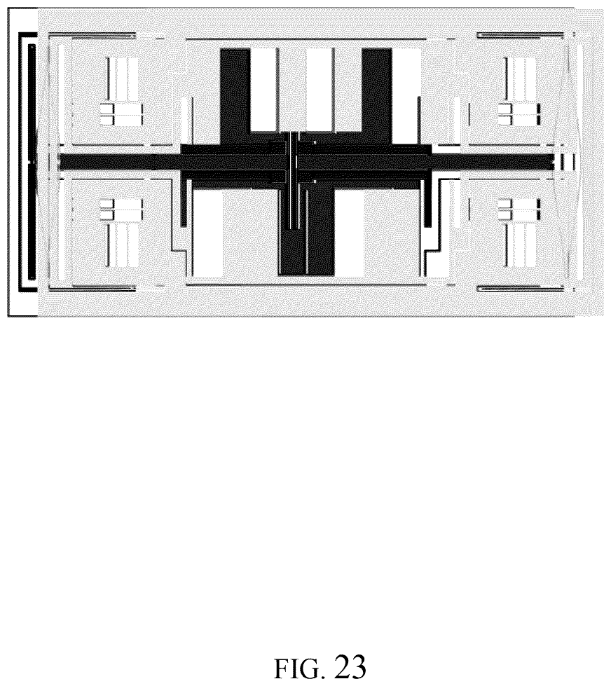

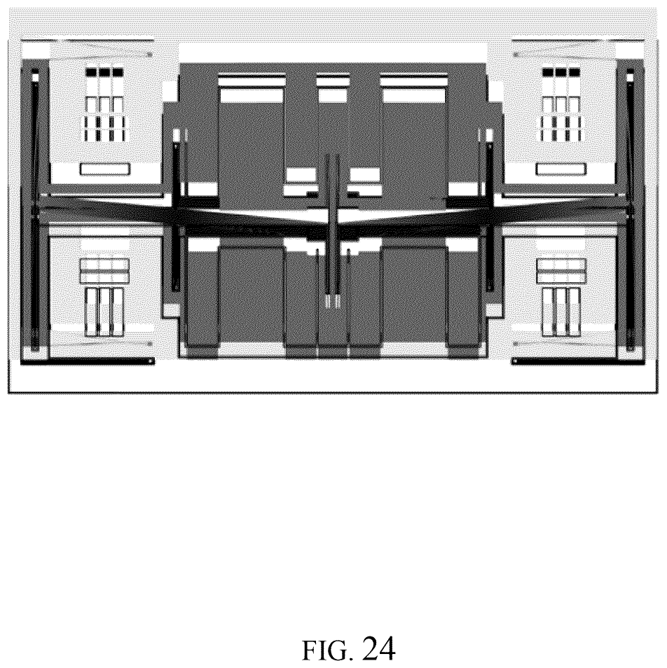

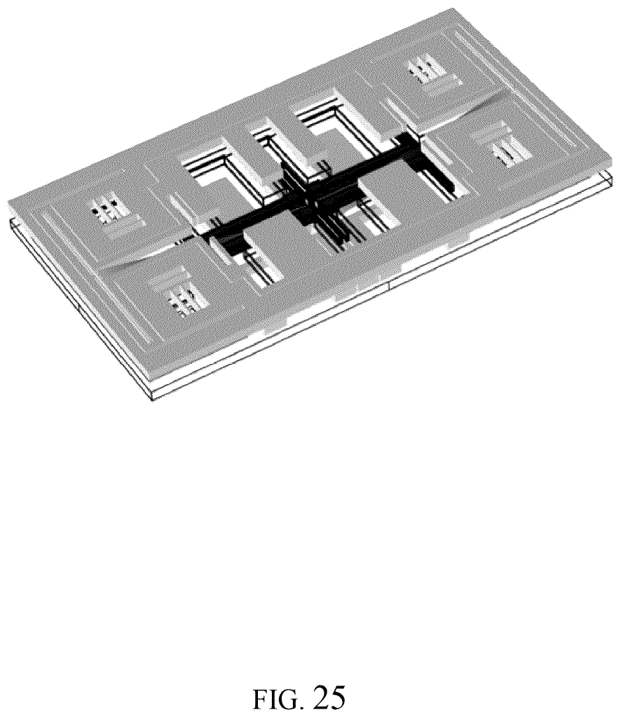

Specifically, supplementary description is made for the detection electrode plate 26 in the Z-axis and the corresponding capacitor electrode plates (as illustrated in FIG. 22) on the outer coupling structure 24 or the cavity cap. Along axis 3 (X-axis), the distances from Z1+ to Z4+ capacitor electrode plates to axis 3 are equal to the distances from Z1− to Z4− capacitor electrode plates to axis 3, and the distances from Z5+ to Z8+ capacitor electrode plates to axis 3 are also equal to the distances from Z5− to Z8− capacitor electrode plates to axis 3. Therefore, in the case that the structure undergoes rotation or bending along axis 3, the deformations of the positive and negative capacitor electrode plates counteract each other, and thus the capacitance offset is 0. Along axis 4 (X-axis), the distances from Z1+ and Z2+ and Z5+ and Z6+ capacitor electrode plates to axis 4 are equal to the distances from Z1− and Z2− and Z5− and Z6− capacitor electrode plates to axis 4, and the distances from Z3+ and Z4+ and Z7+ and Z8+ to axis 4 are equal to the distances from Z1− and Z2− and Z5− and Z6− capacitor electrode plates to axis 4. Therefore, in the case that the structure undergoes rotation or bending along axis 4, the deformations of the positive and negative capacitor electrode plates counteract each other, and thus the capacitance offset is 0. FIG. 23 to FIG. 25 illustrate X-axis, Y-axis, and Z-axis detection modalities respectively. This arrangement further reduces the initial capacitance offset along the Z-axis.

Compared to the related art, in the accelerometer according to the embodiments of the present disclosure, the two seesaw structures are oppositely arranged, and the outer coupling structure includes the outer coupling structure inner ring that is coupled to the outer sides of the two seesaw structures and the outer coupling structure outer ring that encircles the outer circumference of the outer coupling structure inner ring. The accelerometer further includes the detection electrode plate secured to the side, close to the outer coupling structure, of the inner coupling structure; and the anchors are evenly distributed at the center of the outer coupling structure, and the inner coupling structure is distributed in a ring-shaped pattern around the anchors. This minimizes the impact of a stress on the structure during the manufacturing process, thereby reducing process errors. Moreover, in the case that the outer coupling structure is deformed under a stress, the positive and negative capacitor electrode plates, in their initial state (without acceleration), undergo similar deformations, thereby reducing the capacitance offset and enhancing the overall robustness of the structure. The detection structure further includes the first elastic member connecting the outer coupling structure inner ring to the corresponding seesaw structure, the second elastic member connecting the outer coupling structure inner ring to the outer coupling structure outer ring, and a third elastic member connecting the detection plate to the corresponding seesaw structure. With the configuration of multiple elastic members, the detection effect is enhanced.

Described above are merely exemplary embodiments of the present disclosure. It should be noted that persons of ordinary skill in the art would make various improvements without departing from the inventive concept of the present disclosure, and such improvements shall fall within the protection scope of the present disclosure.

What is claimed is:

1. An accelerometer, comprising: an outer coupling structure, a detection structure connected to the outer coupling structure, and an inner coupling structure; wherein the detection structure comprises anchors connected to the outer coupling structure, two seesaw structures elastically connected to the anchors, and a displacement detection component arranged on both the outer coupling structure and the inner coupling structure; wherein inner sides of the two seesaw structures are coupled to the inner coupling structure, and outer sides of the two seesaw structures are coupled to the outer coupling structure; the two seesaw structures are oppositely arranged, and the outer coupling structure comprises an outer coupling structure inner ring that is coupled to the outer sides of the two seesaw structures and an outer coupling structure outer ring that encircles an outer circumference of the outer coupling structure inner ring;
wherein the accelerometer further comprises a detection electrode plate secured to a side, close to the outer coupling structure, of the inner coupling structure; and the anchors are evenly distributed at a center of the outer coupling structure, and the inner coupling structure is distributed around the anchors; and
the detection structure further comprises a first elastic member connecting the outer coupling structure inner ring to a seesaw structure corresponding to the outer coupling structure inner ring, a second elastic member connecting the outer coupling structure inner ring to the outer coupling structure outer ring, and a third elastic member connecting the detection electrode plate to a seesaw structure corresponding to the detection electrode plate.

2. The accelerometer according to claim 1, wherein four anchors are provided, and are evenly distributed at a geometric center of the outer coupling structure.

3. The accelerometer according to claim 1, wherein a plurality of positive and negative capacitor electrode plates on the outer coupling structure inner ring and the inner coupling structure are staggered.

4. The accelerometer according to claim 1, wherein the inner coupling structure is provided with a plurality of connection beams, and the inner coupling structure is connected to the two seesaw structures via the plurality of connection beams.

5. The accelerometer according to claim 1, wherein a length direction of the outer coupling structure is defined as a direction of an X-axis, a width direction of the outer coupling structure is defined as a direction of a Y-axis, and a thickness direction of the outer coupling structure is defined as a direction of a Z-axis; the two seesaw structures are symmetrically arranged on the outer coupling structure with respect to the Y-axis; the displacement detection component comprises a plurality of X-axis acceleration detection units and a plurality of Y-axis acceleration detection units arranged on the outer coupling structure, and a plurality of Z-axis acceleration detection units arranged on the outer coupling structure inner ring and the inner coupling structure; the plurality of Y-axis acceleration detection units being arranged adjacent to the plurality of X-axis acceleration detection units;
wherein the plurality of X-axis acceleration detection units are symmetrically distributed with respect to the Y-axis, and the plurality of X-axis acceleration detection units are symmetrically distributed with respect to the X-axis;
wherein the plurality of Y-axis acceleration detection units are symmetrically distributed with respect to the X-axis, and the plurality of Y-axis acceleration detection units are symmetrically distributed with respect to the Y-axis; and
wherein the plurality of Z-axis acceleration detection units are centrally symmetrically distributed with respect to a coordinate origin.

6. The accelerometer according to claim 5, wherein the detection electrode plate comprises a first detection plate, a second detection plate, a third detection plate, a fourth detection plate, a fifth detection plate, a sixth detection plate, a seventh detection plate, an eighth detection plate, a ninth detection plate, and a tenth detection plate that are arranged at intervals in a ring-shaped pattern on the outer coupling structure inner ring and the inner coupling structure; the first detection plate, the second detection plate, the third detection plate, the fourth detection plate, and the fifth detection plate are arranged symmetrically to the sixth detection plate, the seventh detection plate, the eighth detection plate, the ninth detection plate, and the tenth detection plate respectively with respect to the X-axis;
wherein capacitor electrode plates on the first detection plate, the second detection plate, the third detection plate, the fourth detection plate, and the fifth detection plate are arranged in a configuration of staggered positive and negative electrodes; and
wherein capacitor electrode plates on the sixth detection plate, the seventh detection plate, the eighth detection plate, the ninth detection plate, and the tenth detection plate have polarity opposite to the capacitor electrode plates on the first detection plate, the second detection plate, the third detection plate, the fourth detection plate, and the fifth detection plate respectively.

7. The accelerometer according to claim 5, wherein the detection electrode plate comprises a first detection plate, a second detection plate, a third detection plate, a fourth detection plate, a fifth detection plate, a sixth detection plate, a seventh detection plate, an eighth detection plate, a ninth detection plate, a tenth detection plate, an eleventh detection plate, a twelfth detection plate, a thirteenth detection plate, a fourteenth detection plate, a fifteenth detection plate, and a sixteenth detection plate that are arranged at intervals in a ring-shaped pattern on the outer coupling structure inner ring and the inner coupling structure; the first detection plate, the second detection plate, the third detection plate, the fourth detection plate, the fifth detection plate, the sixth detection plate, the seventh detection plate, and the eighth detection plate are arranged symmetrically to the ninth detection plate, the tenth detection plate, the eleventh detection plate, the twelfth detection plate, the thirteenth detection plate, the fourteenth detection plate, the fifteenth detection plate, and the sixteenth detection plate respectively with respect to the X-axis;
wherein capacitor electrode plates on the first detection plate, the second detection plate, the third detection plate, the fourth detection plate, the fifth detection plate, the sixth detection plate, the seventh detection plate, and the eighth detection plate are arranged in a configuration of staggered positive and negative electrodes; and
wherein capacitor electrode plates on the ninth detection plate, the tenth detection plate, the eleventh detection plate, the twelfth detection plate, the thirteenth detection plate, the fourteenth detection plate, the fifteenth detection plate, and the sixteenth detection plate have polarity opposite to the capacitor electrode plates on the first detection plate, the second detection plate, the third detection plate, the fourth detection plate, the fifth detection plate, the sixth detection plate, the seventh detection plate, and the eighth detection plate respectively.

8. The accelerometer according to claim 5, wherein the detection electrode plate comprises a first detection plate, a second detection plate, a third detection plate, a fourth detection plate, a fifth detection plate, a sixth detection plate, a seventh detection plate, and an eighth detection plate that are arranged at intervals in a ring-shaped pattern on the outer coupling structure inner ring and the inner coupling structure; the first detection plate, the second detection plate, the third detection plate, and the fourth detection plate are arranged symmetrically to the fifth detection plate, the sixth detection plate, the seventh detection plate, and the eighth detection plate respectively with respect to the X-axis;
wherein capacitor electrode plates on the first detection plate, the second detection plate, the third detection plate, and the fourth detection plate are arranged in a configuration of stagged positive and negative electrodes; and
wherein capacitor electrode plates on the fifth detection plate, the sixth detection plate, the seventh detection plate, and the eighth detection plate have polarity opposite to the capacitor electrode plates on the first detection plate, the second detection plate, the third detection plate, and the fourth detection plate respectively.

9. The accelerometer according to claim 5, wherein the detection electrode plate comprises a first detection plate, a second detection plate, a third detection plate, a fourth detection plate, a fifth detection plate, and a sixth detection plate that are arranged at intervals in a ring-shaped pattern on the outer coupling structure inner ring and the inner coupling structure; the first detection plate, the second detection plate, and the third detection plate are arranged symmetrically to the fourth detection plate, the fifth detection plate, and the sixth detection plate respectively with respect to the X-axis;
wherein capacitor electrode plates on the first detection plate, the second detection plate, and the third detection plate are arranged in a configuration of stagged positive and negative electrodes; and
wherein capacitor electrode plates on the fourth detection plate, the fifth detection plate, and the sixth detection plate have polarity opposite to the capacitor electrode plates on the first detection plate, the second detection plate, and the third detection plate respectively.

10. The accelerometer according to claim 5, wherein the detection electrode plate comprises a first detection plate, a second detection plate, a third detection plate, a fourth detection plate, a fifth detection plate, a sixth detection plate, a seventh detection plate, an eighth detection plate, a ninth detection plate, a tenth detection plate, an eleventh detection plate, a twelfth detection plate, a thirteenth detection plate, a fourteenth detection plate, a fifteenth detection plate, and a sixteenth detection plate that are juxtaposed along the direction of the X-axis on the outer coupling structure inner ring and the inner coupling structure; the first detection plate, the second detection plate, the third detection plate, the fourth detection plate, the fifth detection plate, the sixth detection plate, the seventh detection plate, and the eighth detection plate are arranged symmetrically to the ninth detection plate, the tenth detection plate, the eleventh detection plate, the twelfth detection plate, the thirteenth detection plate, the fourteenth detection plate, the fifteenth detection plate, and the sixteenth detection plate respectively with respect to the X-axis;
wherein capacitor electrode plates on the first detection plate and the eighth detection plate have the same polarity, and capacitor electrode plates on any adjacent two of the second detection plate to the seventh detection plate have the same polarity and are arranged in a configuration of staggered positive and negative electrodes relative to the capacitor electrode plates on the first detection plate and the eighth detection plate respectively; and
wherein capacitor electrode plates on the ninth detection plate, the tenth detection plate, the eleventh detection plate, the twelfth detection plate, the thirteenth detection plate, the fourteenth detection plate, the fifteenth detection plate, and the sixteenth detection plate have polarity opposite to the capacitor electrode plates on the first detection plate, the second detection plate, the third detection plate, the fourth detection plate, the fifth detection plate, the sixth detection plate, the seventh detection plate, and the eighth detection plate respectively.
